(19) United States
(12) Patent Application Publication
(10) Pub. No.: US 2025/0267452 A1
(43) Pub. Date: Aug. 21, 2025

(54) WIRELESS COLLECTION OF DATA FROM OFFLINE PRODUCT DISPENSERS AND REMOTE ANALYSIS OF THE SAME

(71) Applicant: Wayne Fueling Systems LLC, Austin, TX (US)

(72) Inventors: Bipin Gautam Taksande, Navi Mumbai (IN); Shreyas Chindarkar, Navi Mumbai (IN); Mayur Kasurde, Navi Mumbai (IN); Pritesh Potdar, Navi Mumbai (IN); Prashant Patil, Navi Mumbai (IN)

(21) Appl. No.: 19/056,151

(22) Filed: Feb. 18, 2025

(30) Foreign Application Priority Data
Feb. 21, 2024 (IN) 202411012314

(51) Int. Cl. H04W 12/037; G06F 9/54

(52) U.S. Cl. CPC H04W 12/037; G06F 9/547

(57) ABSTRACT

Various exemplary devices, systems, and methods for wireless collection of data from offline product dispensers and remote analysis of the same are provided. In general, an application executing on a mobile device is configured to establish a wireless communication session between the mobile device and a short-range wireless communication module connected to an offline product dispenser. In an exemplary implementation, the application is configured to communicate with the offline product dispenser via the wireless communication module in order to collect information regarding the offline product dispenser. The application is further configured to transmit the collected information to a remote server for storage and processing.

### CROSS REFERENCE TO RELATED APPLICATION

This application claims priority to Indian Application No. 202411012314 filed on Feb. 21, 2024, and entitled “WIRELESS COLLECTION OF DATA FROM OFFLINE PRODUCT DISPENSERS AND REMOTE ANALYSIS OF THE SAME,” which is hereby incorporated by reference in its entirety.

### FIELD

The present disclosure relates to wireless collection of data from offline product dispensers and remote analysis of the same.

### BACKGROUND

Various types of product dispensers are available for dispensing products, such as fuel, to customers. Due to high usage rates and time, product dispensers can be subject to deterioration, which can result in higher operational costs and lower service quality. In order to maintain dispensers in suitable operational condition, preventive maintenance, which can include mechanical repair and/or software updates to the product dispenser system, is performed. Typically, the original equipment manufacturer (OEM) uses various techniques to monitor and evaluate performance of the product dispensers to determine when such maintenance is required.

In some markets, product dispensers (e.g., fuel dispensers) operate while offline, that is, lacking any connection to the Internet or a remote server. This poses a potential problem since the OEM is unable to remotely connect to an offline dispenser and monitor its performance or condition for the purpose of determining when maintenance is needed. Furthermore, product dispensers are often moved to different locations based on various location-specific business considerations. But the lack of remote connectivity prevents an OEM from tracking the movement of an offline dispenser, creating a situation where the OEM is entirely unaware of where its product dispensers are located.

Even further, OEMs are typically responsible for providing warranty and security for their dispensers. In order to do so, it is crucial that the status of the product dispensers be closely monitored to detect potential mis-operations or suspicious tampering. Because offline dispensers have no means of sending operational data to a centralized remote server, implementing the monitoring necessary for the OEM to ensure these security measures becomes extremely burdensome, often requiring engineers to visit each offline dispenser for regular in-person evaluations.

### SUMMARY

In general, devices, systems, and methods for wireless collection of data from offline product dispensers and remote analysis of the same are provided.

In one aspect, a method is provided that in one implementation includes establishing, by an application executing on a mobile device, a wireless communication session between the mobile device and a short-range wireless communication module connected to an offline product dispenser. The method also includes sending, by the application and via the wireless communication session, one or more requests for information regarding the offline product dispenser to the short-range wireless communication module. The method further includes receiving, by the application and via the wireless communication session, the information regarding the offline product dispenser from the short-range wireless communication module, in response to the one or more requests. The offline product dispenser can be configured to transmit the information regarding the offline product dispenser to the short-range wireless communication module via a communication channel of the offline product dispenser. The method further includes transmitting, by the application, the information regarding the offline product dispenser to a remote server configured to store and process the information regarding the offline product dispenser.

The method can vary in any number of ways. For example, the application can receive, via the wireless communication session, the information regarding the offline product dispenser in an encrypted format from the short-range wireless communication module, in response to the one or more requests.

For another example, the application can transmit the information regarding the offline product dispenser in the encrypted format to the remote server, where the remote server is configured to perform decryption of the information regarding the offline product dispenser upon receipt.

For yet another example, the application can securely transmit the information regarding the offline product dispenser in the encrypted format to the remote server using a Hypertext Transfer Protocol Secure (HTTPS) application programming interface (API).

For still another example, the application can be unable to perform decryption of the information regarding the offline product dispenser, such that a user is prevented from accessing contents of the information regarding the offline product dispenser on the mobile device.

For yet another example, the application can send, via the wireless communication session, the one or more requests for the information regarding the offline product dispenser to the short-range wireless communication module according to a predefined request flow defining a sequence of requests to send to the offline product dispenser.

For another example, the offline product dispenser can only provide the information regarding the offline product dispenser to the short-range wireless communication module for communication to the mobile device when a sequence of the one or more requests sent by the mobile device matches the sequence of requests defined by the predefined request flow.

For still another example, the sequence of requests defined by the predefined request flow can include at least: a first request for a dispenser identifier (ID) of the offline product dispenser followed by a second request for operational data stored in memory of the offline product dispenser.

For another example, the method can further include, detecting, by the application, a disruption of the wireless communication session during transmission of the operational data from the short-range wireless communication module to the mobile device; and re-establishing, by the application, the wireless communication session between the mobile device and the short-range wireless communication module using the dispenser ID.

For still another example, the method can further include, sending, by the application and via the wireless communication session, one or more first requests for first information regarding the offline product dispenser to the short-range wireless communication module; receiving, by the application and via the wireless communication session, the first information regarding the offline product dispenser from the short-range wireless communication module, in response to the first one or more requests; transmitting, by the application, the first information regarding the offline product dispenser to the remote server; and after transmitting the first information regarding the offline product dispenser to the remote server, sending, by the application and via the wireless communication session, one or more second requests for second information regarding the offline product dispenser to the short-range wireless communication module, the second information regarding the offline product dispenser being different than the first information regarding the offline product dispenser.

For yet another example, the short-range wireless communication module can be configured to communicate using a short-range communication protocol selected from a group consisting of: a Bluetooth protocol, a Wi-Fi protocol, a near-field communication (NFC) protocol, and an ultra-wideband (UWB) protocol.

For another example, the communication channel of the offline product dispenser via which the offline product dispenser transmits the information regarding the offline product dispenser to the short-range wireless communication module can be a serial communication channel.

For still another example, the short-range wireless communication module can be connected externally to a serial communication port of the offline product dispenser connected to the serial communication channel, the offline product dispenser being configured to transmit the information regarding the offline product dispenser to the short-range wireless communication module over the serial communication port.

For yet another example, the method can further include, performing, by the application and via the application, a user authentication procedure prior to establishing the wireless communication session between the mobile device and the short-range wireless communication module, wherein the wireless communication session is only established when the user authentication procedure is successful.

For another example, the method can further include, performing, by the application and via the application, an initial pairing procedure between the mobile device and the short-range wireless communication module, wherein the wireless communication session is established after completion of the initial pairing procedure.

For still another example, the remote server, having processed the information regarding the offline product dispenser, can be further configured to provide a visual depiction of the processed information regarding the offline product dispenser to a user interface.

For yet another example, the application can transmit the information regarding the offline product dispenser to the remote server without having processed the information regarding the offline product dispenser.

For another example, the offline product dispenser can be a fuel dispenser.

In another aspect, an apparatus is provided that in one implementation includes one or more network interfaces to communicate with a network, a processor coupled to the one or more network interfaces and configured to execute one or more processes, and a memory configured to store a process executable by the processor. When executed the process can cause the processor to establish, via an application executing on the apparatus, a wireless communication session between the mobile device and a short-range wireless communication module connected to an offline product dispenser. The apparatus can also send, via the wireless communication session, one or more requests for information regarding the offline product dispenser to the short-range wireless communication module, and then receive, via the wireless communication session, the information regarding the offline product dispenser from the short-range wireless communication module, in response to the one or more requests. The offline product dispenser can transmit the information regarding the offline product dispenser to the short-range wireless communication module via a communication channel of the offline product dispenser. In addition, the apparatus can transmit the information regarding the offline product dispenser to a remote server configured to store and process the information regarding the offline product dispenser.

In yet another aspect, a system is provided that in one implementation includes an offline product dispenser connected to a short-range wireless communication module, the offline product dispenser being configured to communicate with the short-range wireless communication module via a communication channel of the offline product dispenser, a remote server, and a mobile device executing an application. In one embodiment, the application is configured to establish a wireless communication session between the mobile device and the short-range wireless communication module, send, via the wireless communication session, one or more requests for information regarding the offline product dispenser to the short-range wireless communication module, and receive, via the wireless communication session, the information regarding the offline product dispenser from the short-range wireless communication module, in response to the one or more requests. The offline product dispenser can transmit the information regarding the offline product dispenser to the short-range wireless communication module via the communication channel. In addition, the application can be further configured to transmit the information regarding the offline product dispenser to the remote server being configured to store and process the information regarding the offline product dispenser.

### BRIEF DESCRIPTION OF DRAWINGS

The embodiments described above will be more fully understood from the following detailed description taken in conjunction with the accompanying drawings. The drawings are not intended to be drawn to scale. For purposes of clarity, not every component may be labeled in every drawing. In the drawings:

FIG. 1 is a schematic view of one implementation of a system for wireless collection of data from offline product dispensers and remote analysis of the same;

FIG. 2 is a schematic view of one implementation of a fuel dispenser;

FIG. 3 is a perspective view of another implementation of a fuel dispenser;

FIG. 4 is a schematic view of one implementation of a mobile device;

FIGS. 5A and 5B illustrate one implementation of a process for wireless collection of data from offline product dispensers and remote analysis of the same;

FIG. 6 shows one implementation of a login screen of an application;

FIG. 7 shows one implementation of an invalid login screen of the application of FIG. 6;

FIG. 8 shows one implementation of a successful login screen of the application of FIG. 6;

FIG. 9 shows one implementation of an available connections screen of the application of FIG. 6;

FIG. 10 shows one implementation of a connection activation screen of the application of FIG. 6;

FIG. 11 shows one implementation of a progress update screen of the application of FIG. 6;

FIG. 12 shows one implementation of a process completion screen of the application of FIG. 6;

FIG. 13 shows one implementation of a user portal screen provided by a remote server;

FIG. 14 shows one implementation of another user portal screen provided by the remote server of FIG. 13; and

FIG. 15 shows one implementation of yet another user portal screen provided by the remote server of FIG. 13.

### DETAILED DESCRIPTION

Certain exemplary embodiments will now be described to provide an overall understanding of the principles of the structure, function, manufacture, and use of the devices, systems, and methods disclosed herein. One or more examples of these embodiments are illustrated in the accompanying drawings.

Further, in the present disclosure, like-named components of the embodiments generally have similar features, and thus within a particular embodiment each feature of each like-named component is not necessarily fully elaborated upon. Additionally, to the extent that linear or circular dimensions are used in the description of the disclosed systems, devices, and methods, such dimensions are not intended to limit the types of shapes that can be used in conjunction with such systems, devices, and methods. A person skilled in the art will recognize that an equivalent to such linear and circular dimensions can easily be determined for any geometric shape. Sizes and shapes of the systems and devices, and the components thereof, can depend at least on the dimensions of the subject in which the systems and devices will be used, the size and shape of components with which the systems and devices will be used, and the methods with which the systems and devices will be used.

Various exemplary devices, systems, and methods for wireless collection of data from offline product dispensers and remote analysis of the same are provided. In general, product dispensers are configured to provide a product, such as fuel, to a customer via a dispensing machine (e.g., a fuel pump assembly). Diagnosis of product or fuel dispensers involves sending operational data obtained from the dispensers to a centralized location where their performance can be evaluated and problems can be detected. This allows OEMs to monitor its product dispensers remotely, saving time and resources.

There is an obstacle to such monitoring, however, in circumstances where the dispensers lack connectivity to remote servers or other network devices. Commonly found in markets where network connectivity is limited, these “offline” product or fuel dispensers do not have means to send data to a centralized server. Consequently, remote monitoring of such dispensers is impossible, causing serious issues as dispensers are often moved to different locations throughout their operational lifespan. An OEM is thus prone to lose track of its product dispensers over time, and at risk of failing to recognize when repairs are needed or tampering has occurred. In many circumstances, the OEM will keep track of its dispensers by sending engineers to visit the dispensers on-site for manual diagnosis on a regular basis, without knowing whether or not maintenance of a dispenser is actually required.

In an exemplary embodiment, an application can be configured for installation on a mobile device to allow the mobile device to wirelessly communicate with an offline product (e.g., fuel) dispenser via a wireless communication module that is connected to the dispenser via a communication channel, such as a serial communication channel, of the dispenser. The wireless communication module can be configured to communicate using a short-range communication protocol (e.g., Bluetooth, Wi-Fi, etc.). The application executing on the mobile device can establish a wireless communication session between the mobile device and the wireless communication module, and the dispenser can in turn provide various information to the mobile device via the wireless communication module, which acts as bridge between the mobile device and the offline dispenser.

Upon receipt of the information provided by the dispenser, the application can initiate transmission of the information to a remote server (e.g., a server managed by the OEM) that stores, parses, and processes the data. The remote server can provide a visual indication of the processed data to a user interface, such as a web portal, enabling operators, managers, engineers, and the like to remotely monitor, assess, and diagnose offline product dispensers in real-time, without having to manually visit each product dispenser to perform an in-person evaluation. This allows for convenient and efficient tracking of inventory, dispenser locations, field trials, and even security breaches.

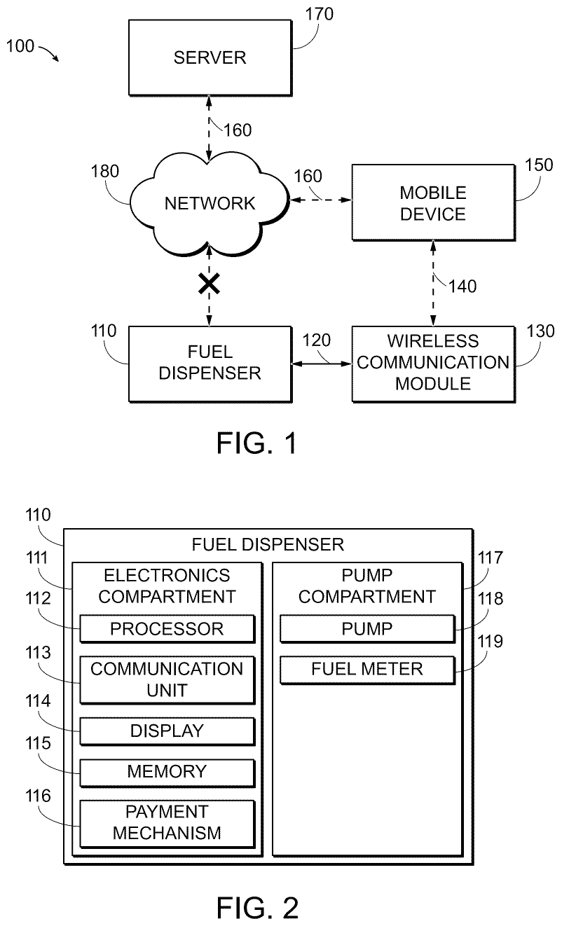

FIG. 1 illustrates one embodiment of a system 100 for wireless collection of data from offline product dispensers and remote analysis of the same. It is noted that the offline product dispenser includes, for example, offline fuel dispensers configured to dispense any type of fuel (e.g., petroleum-based fuels (gasoline), natural gas, ethanol, butanol, methanol, hydrogen fuel, electrical fuel (electricity), synthetic fuels, etc.), or alternatively, non-fuels such as goods and services, or a combination of both. In the description that follows, the offline product dispenser is described primarily with reference to an offline fuel dispenser (e.g., fuel dispenser 110) for illustration purposes. Importantly, while a fuel dispenser is an exemplary embodiment of a product dispenser, the product dispenser as claimed is not limited thereto. Therefore, repeated reference to the fuel dispenser 110 throughout the present disclosure and figures is made for illustration purposes only and should not be construed as limiting the scope of the claims.

As shown in FIG. 1, the system 100 can include a fuel dispenser 110, a wireless communication module 130, a mobile device 150, and a remote server 170. In exemplary embodiment, the fuel dispenser 110 is offline, that is, lacking any connectivity to an external communication network, such as the network 180, or otherwise. Because of this, the fuel dispenser 110 is unable to communicate (i.e., send or receive data) directly with a centralized server, such as the remote server 170, other external devices, such as the mobile device 150, and the like. The configurations of the fuel dispenser 110 and the mobile device 150, respectively, will be described in further detail below with reference to FIGS. 2-4.

Firstly, the fuel dispenser 110 can have a variety of configurations. In general, the fuel dispenser 110 is configured to dispense fuel to a vehicle, a fuel container, or other appropriate receptacle.

FIG. 2 illustrates a schematic view of one implementation of the fuel dispenser 110. As shown, the fuel dispenser 110 can include an electronics compartment 111 and a pump compartment 117. The electronics compartment 111 can contain therein electronics for facilitating payment for fuel (or other goods and services) and for facilitating the dispensing of the fuel. The electronics can include, for example, a processor 112 configured to control various electronic components of the fuel dispenser 110 and dispensing of fuel from the pump compartment 117, a communication unit 113 configured to electronically communicate via a wired and/or wireless communication link, a display 114 configured to display information (e.g., media content, payment information, etc.), a memory 115 configured to store data therein that is readable by the processor 112, and a payment mechanism 116 (e.g., a card reader, a Near Field Communication (NFC) module, etc.) configured to facilitate payment for fuel (and/or other good and/or services).

The display 114 can configured to show information to a user of the fuel dispenser 110. The display 114 can have any of a variety of configurations, such as a cathode ray tube (CRT) screen, a liquid crystal display (LCD) screen, a light emitting diode (LED) screen, a touchscreen, and the like. For example, the display 114 can include a single display. Alternatively, the display 114 can include multiple displays. For example, a first display 114 can be on a front side of the fuel dispenser 110 and a second display 114 can be on a back side of the fuel dispenser 110. As another example, the display 114 can include two displays mounted next to each other to increase an overall display size. As yet another example, the display 114 can include first and second displays mounted next to each other on a front side of the fuel dispenser 110 and can include third and fourth mounted next to each other on a back side of the fuel dispenser 110.

The fuel dispenser 110 can, in some implementations, include at least one media output device in addition to the display 114. For example, the at least one media output device can include a speaker configured to output audio therefrom.

The communication unit 113 can have a variety of configurations. Some fuel dispensers include a communication unit configured to communicate wirelessly with a remote system (e.g., a remote cloud server, a third-party payment authorization system, etc.) according to any of a variety of communication protocols, e.g., TCP/IP, etc. For the purposes of the present disclosure, however, the fuel dispenser 110 is offline. Therefore, the communication unit 113 of the fuel dispenser 110 is unable to communicate directly with the server 170 via the network 180 (e.g., due to the lack of network connectivity in the region where the dispenser 110 is located, the communication unit 113 lacking necessary communication protocols, etc.) or other remote entities.

In some implementations, the communication unit 113 can be configured to communicate over a wired connection in addition to or instead of over a wireless connection. A wired connection can be used, for example, for a local communication link between the fuel dispenser 110 and a local computing system external to the fuel dispenser 110 (e.g., a forecourt controller, an in-store a point of sale (POS) device, etc.). A wired connection may provide more security and/or stability than a wireless connection and/or may allow a legacy fuel dispenser configured to communicate only via one or more wired connections to implement dynamic management of display content as described herein. Wired communication can occur via any of a variety of wired communication protocols, e.g., TCP/IP, etc., as will be appreciated by a person skilled in the art. Some fuel dispensers are manufactured with two-wire connectivity, and the wired communication can accordingly be via two wires, such as via a controller area network bus (CANBus) two wire connection, an RS485 two wire connection, a current loop connection, or other type of two wire connection. Some fuel dispensers are additionally or alternatively manufactured with cable connectivity and can accordingly be configured to provide wired communication via cable connection, such as an Ethernet cable or other network cable. Older fuel dispensers typically have two-wire connectivity capabilities while newer fuel dispensers typically have Ethernet connectivity capabilities instead.

In some implementations, the communication unit 113 can be configured to facilitate wireless communication over a short-range communication link. For example, the communication unit 113 can include a transceiver configured to communicate via any of a variety of short-range wireless techniques, such as a Bluetooth protocol, a Wi-Fi protocol, near field communication (NFC), an ultra-wideband (UWB) protocol, a radio frequency identification (RFID) protocol, etc. Any of a variety of types of wireless connectivity hardware can be used for the short-range wireless connectivity, as will be appreciated by a person skilled in the art. The types of wireless connectivity that the communication unit 113 includes can be chosen by an owner of the fuel dispenser 110 according to the owner's current fueling site setup and/or future fueling site plans, and the communication unit 113 may be manufactured and/or updated accordingly.

The pump compartment 117 of the fuel dispenser 110 can, as in this illustrated implementation, have therein a pump 118 configured to pump fuel from a fuel tank or other reservoir and has therein a fuel meter 119 configured to monitor fuel flow. The pump compartment 117 can include other elements to facilitate fuel dispensing, such as valves, a vapor recovery system, etc., as will be appreciated by a person skilled in the art. The pump compartment 117 can be isolated from the electronics compartment 111 within the dispenser 110 to facilitate safety, security, and/or maintenance, as will be appreciated by a person skilled in the art. Fuel is configured to flow through the pump compartment 117 to a hose (not shown in FIG. 2) and out of a nozzle (not shown in FIG. 2) at an end of the hose. The fuel dispenser 110 can include any number of hoses and associated nozzles.

A person skilled in the art will appreciate that the fuel dispenser 110 can have various other configurations. Various exemplary implementations of fuel dispensers are described further in, for example, U.S. Pat. No. 10,214,411 entitled “Fuel Dispenser Communication” issued Feb. 26, 2019, U.S. Pat. No. 10,269,082 entitled “Intelligent Fuel Dispensers” issued Apr. 23, 2019, U.S. Pat. No. 10,577,237 entitled “Methods And Devices For Fuel Dispenser Electronic Communication” issued Mar. 3, 2020, U.S. Pat. No. 10,726,508 entitled “Intelligent Fuel Dispensers” issued Jul. 28, 2020, U.S. Pat. No. 11,276,051 entitled “Systems And Methods For Convenient And Secure Mobile Transactions” issued Mar. 15, 2022, U.S. Pat. No. 11,429,945 entitled “Outdoor Payment Terminals” issued Aug. 30, 2022, and U.S. Pat. App. Pub. No. 2023/0196360 entitled “Conducting Fuel Dispensing Transactions” published Jun. 22, 2023, which are hereby incorporated by reference in their entireties.

In some implementations, and as referenced above, the fuel dispenser 110 is configured to dispense type(s) of “fuel” in addition to or instead of a petroleum fuel. For example, the fuel dispenser can be configured to dispense hydrogen, liquid propane gas (LPG) or compressed natural gas (CNG), water, electricity, or the like. It will be understood that the fueling stations and the fuel dispensers described herein are not limited to petroleum gasoline in liquid format and that other types of fuel dispensers configured to dispense alternate types of “fuel” can be envisioned. For example, in some implementations, the fuel dispenser can be a hydrogen fuel dispenser. As another example, in some implementations, the fuel dispenser can be a natural gas fuel dispenser. As yet another example, in some implementations, the fuel dispenser can be an electrical fuel dispenser configured to dispense electricity.

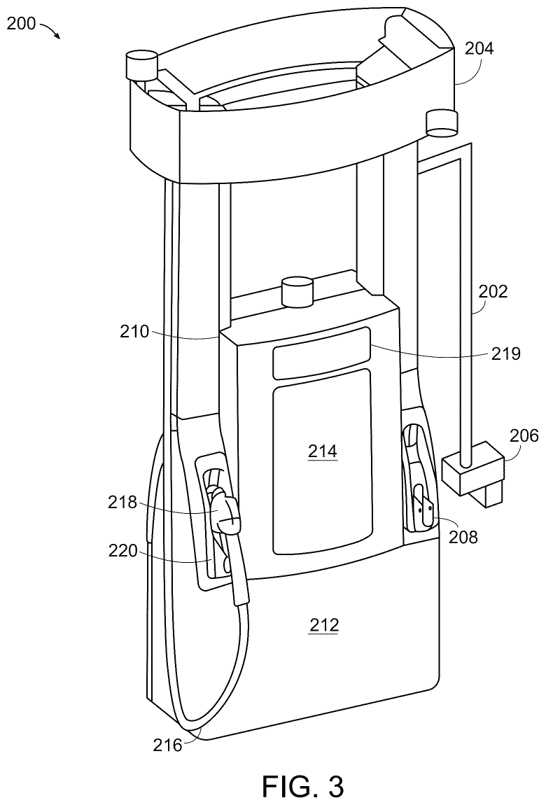

FIG. 3 illustrates a perspective view of one implementation of a fuel dispenser 200 that can be used as the fuel dispenser 110 of FIG. 1 and that is configured to dispense electrical fuel (e.g., electricity). As in this illustrated implementation, the fuel dispenser 200 can include a charging cable 202 coupled to a body 204 of the fuel dispenser 200 at one end and configured to deliver electricity to a charging connector 206 coupled to an opposite end. The charging connector 206 is configured to couple to a charging port of a vehicle (not shown in FIG. 3) and to deliver the electricity provided by the fuel dispenser 200, via the charging cable 202, to the vehicle when coupled to the charging port. When not in use, the charging connector 206 is configured to be stored in a charger receptacle 208 formed on the dispenser body 204.

Similar to the configuration of FIG. 2, the dispenser body 204 can include an electronics compartment 210 (e.g., electronics compartment 111) and a pump compartment 212 (e.g., electronics compartment 117). The pump compartment 212 is isolated from the electronics compartment 210 within the fuel dispenser 200 to facilitate safety, security, and/or maintenance, as will be appreciated by a person skilled in the art. Fuel is thus not allowed to flow from the pump compartment 212 to the electronics compartment 210 and instead flows from the pump compartment 212 through a hose 216 to a nozzle 218 for dispensing. As will be appreciated by a person skilled in the art, the nozzle 218 can be configured to dispense fuel from the fuel dispenser 200 as pumped therefrom by the pump. The fuel dispenser 200 can also include a nozzle receptacle 220 configured to store the nozzle 208 when not in use.

The fuel dispenser 200 of FIG. 3 is thus configured to dispense fuel as electricity via the charging connector 206 and to dispense another type of fuel via the nozzle 218. In other implementations, a fuel dispenser can be configured to dispense fuel only as electricity or to dispense only one or more types of fuel that are not electricity.

The fuel dispenser 200 can also include a display 214 (e.g., display 114). The display 214 in this illustrated implementation includes a first display on one side of the dispenser 200 and a second display (obscured in FIG. 3) on the other, opposite side of the dispenser 200. Furthermore, in some implementations, the fuel dispenser 200 can include a payment terminal 219 (e.g., payment mechanism 116) configured to accept payment for goods and/or services is configured to allow secure access thereto, e.g., for maintenance purposes, via receipt of a one-time password. The payment terminal 219 can be configured to dispense a good and to accept payment for goods and/or services, for example a fuel dispenser, a vending machine, and the like. Examples of goods and services include fuel, a food item, a beverage, a parking space, a pharmacy item, groceries to be delivered, a car wash, a tire pressure check, public transit, and the like. Examples of payment terminals configured to accept payment for goods and/or services without dispensing a good include parking meters, payment kiosks (such as at a parking garage, and the like), and the like.

Referring again to FIG. 1, the mobile device 150 can have a variety of configurations. In general, the mobile device 150 is configured to be portable by a user between different locations at which fuel dispensers are located. The mobile device 150 can thus be used in connection with maintenance of the fuel dispenser 110 shown in FIG. 1 in addition to a plurality of additional fuel dispensers, at least one of which may be located at a same fueling site as the fuel dispenser 110 and/or at least one of which may be located elsewhere. Maintenance personnel typically travel between different locations to perform maintenance on different fuel dispensers, so a user being able to use the mobile device 150 in connection with maintenance of multiple fuel dispensers may make the maintenance personnel's job easier and/or require the maintenance personnel to carry less equipment since the maintenance personnel will typically already be carrying a mobile device.

Examples of the mobile device 150 include a mobile phone, a tablet, a smart watch, a laptop, a personal digital assistant, and the like.

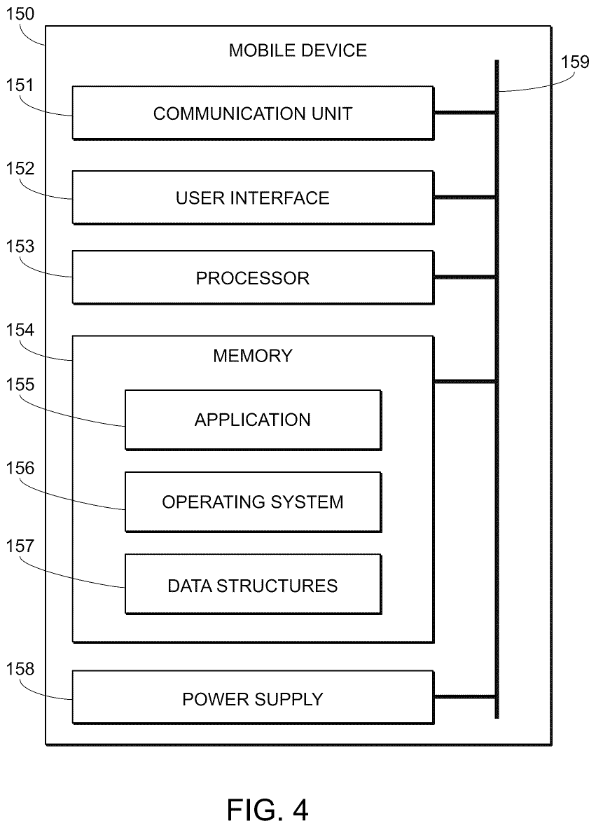

FIG. 4 illustrates a schematic view of one implementation of the mobile device 150. As shown, the mobile device 150 can include a communication unit 151, a user interface 152, a processor 153, and a memory 154. Each of these components can be interconnected via a system bus 159 and powered by a power supply 158.

The communication unit 151 can be configured to electronically communicate wirelessly over a network (e.g., network 180) using one or more network interfaces which include the mechanical, electrical, and signaling circuitry for communicating data over communication links, such as communication link 160, coupled to the network 180. The communication unit 151 can thus be configured to facilitate the mobile device's communication with the wireless communication module 130 over a first communication link 140 and with the remote server 170 over a second communication link 160.

The communication unit 151 can have a variety of configurations. For example, the communication unit 151 can configured to communicate wirelessly, which may facilitate communication with the server 170 and downloading of an application 155 to the mobile device 150 (e.g., from the server 170 or from another source). The network interfaces of the communication unit 151 can be configured to transmit and/or receive data using a variety of different communication protocols, e.g., Bluetooth protocol, cellular protocol, WI-FI protocol, near field communication (NFC), a radio frequency identification (RFID) protocol, etc. Any of a variety of types of wireless connectivity hardware can be used for the wireless connectivity, as will be appreciated by a person skilled in the art. The wireless communication can be according to any of a variety of communication protocols, e.g., TCP/IP, etc., as will also be appreciated by a person skilled in the art. The wireless connectivity may facilitate wireless mesh network communication, as will be appreciated by a person skilled in the art. Furthermore, a physical network interface of the communication unit 151 can also be used to implement one or more virtual network interfaces, such as for virtual private network (VPN) access, known to those skilled in the art.

In some implementations, the communication unit 151 can configured to communicate over a wired connection in addition to a wireless connection. A wired connection may be used, for example, for a local communication link between the mobile device 150 and the fuel dispenser 110. Wired communication can occur via any of a variety of wired communication protocols, e.g., TCP/IP, etc., as will be appreciated by a person skilled in the art.

The user interface 152 can be configured to facilitate interaction of the user with the mobile device 150. In an exemplary implementation, the user interface 152 can include a display configured to show information thereon. The display can have any of a variety of configurations, such as a cathode ray tube (CRT) screen, a liquid crystal display (LCD) screen, a light emitting diode (LED) screen, a touchscreen, and the like, as will be appreciated by a person skilled in the art. The display can include a single display or can include multiple displays.

The processor 153 can be configured to control various electronic components of the mobile device 150 and to execute instructions stored in the memory 154. The memory 154 can include a plurality of storage locations that are addressable by the processor 153 and the communication unit 151 for storing software programs and data structures associated with the embodiments described herein. The processor 153 can include necessary elements or logic adapted to execute the software programs and manipulate the data structures 157. An operating system 156, portions of which are typically resident in memory 154 and executed by the processor 153, can functionally organize the mobile device 150 by, inter alia, invoking network operations in support of software processors and/or services executing on the device 150.

The memory 154 can further configured to store the application 155 therein once the application 155 has been installed on the mobile device 150. As would be appreciated, the application 155 can generally refer to a computer program or computer software package configured for execution by a computing device to carry out one or more tasks. Aspects of the application 155, which can enable wireless collection of data from the offline fuel dispenser 110 via the wireless communication module 130 and analysis of the collected data by the remote server 170, will be discussed in further detail below.

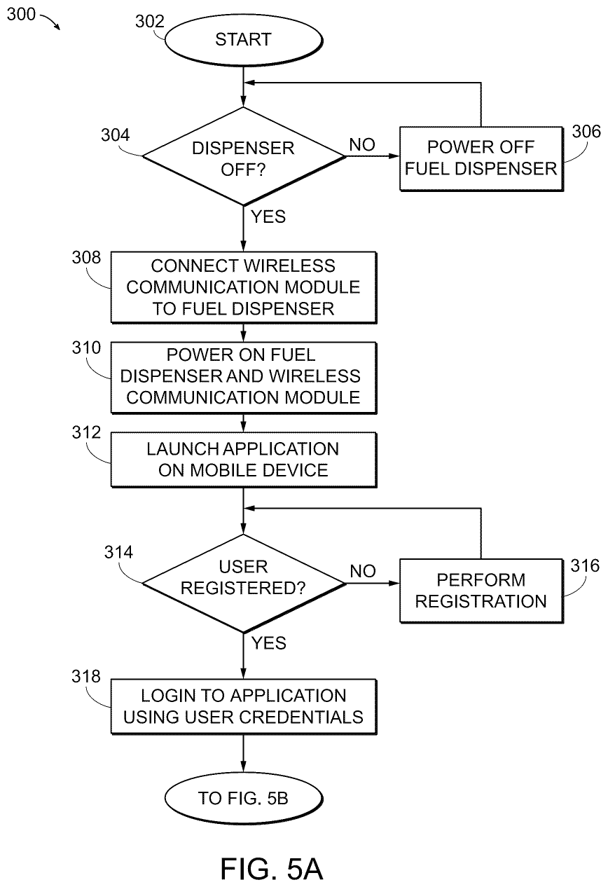

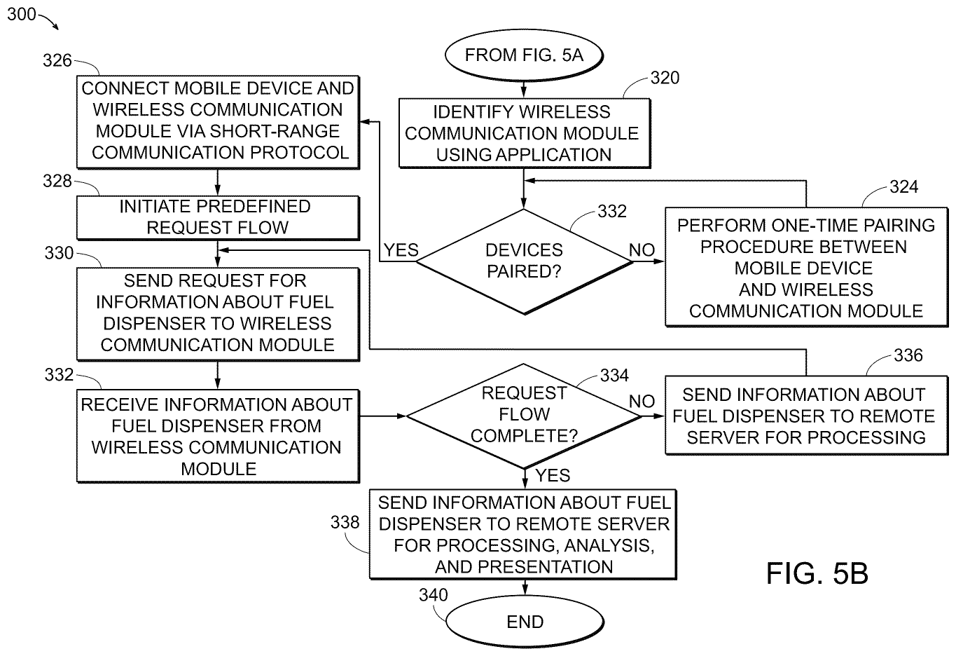

FIGS. 5A and 5B illustrate one implementation of a process 300 for wireless collection of data from offline fuel dispensers and remote analysis of the same, in accordance with one or more embodiments described herein. The process 300 is described with respect to the system 100 of FIG. 1 for case of explanation but can be similarly performed with other systems. The process 300 starts at step 302, and continues to step 304, where it can be determined whether the offline fuel dispenser 110 has been powered off. If not, the fuel dispenser 110 can be powered off, at step 306.

Once the fuel dispenser 110 has been powered off, the dispenser 110 can be connected to the wireless communication module 130, at step 308. In some embodiments, the wireless communication module 130 can be a short-range wireless communication module configured to communicate using a short-range wireless communication protocol, such as Bluetooth, Wi-Fi, NFC, ultra-wideband (UWB), and the like. In the case of Bluetooth, specifically, the wireless communication module 130 can be an ESP32 or HC-05 Bluetooth-enabled transmitter, as an example. The wireless communication module 130 can also be configured to operate in a low-power mode, e.g., as a low-power transmitter or a Bluetooth Low Energy (BLE) device.

The wireless communication module 130 can be physically connected to the offline fuel dispenser 110 via a communication channel of the fuel dispenser 110 (e.g., as an external module). In one implementation, the communication channel can be a serial communication channel, via a serial port (RS232 or RS485) of the fuel dispenser 110, resulting in serial communication link 120, as shown in FIG. 1. By doing so, the wireless communication module 130 can access and collect critical operational data stored in memory 115 (e.g., Flash, NVRAM, etc.) of the dispenser 110, which can transmit such data to the wireless communication module 130 over the serial port. In another implementation, the wireless communication module 130 can be an internal component of the fuel dispenser 110, e.g., part of the communication unit 113.

Upon connecting the wireless communication module 130 to the offline fuel dispenser 110, both devices can be powered on, at step 310. The wireless communication module 130 can then access data stored in memory 115 of the fuel dispenser 110, although collection of such data may not occur until commands to retrieve the data are received from the mobile device 150, as discussed further below.

Turning to the mobile device 150, the application 155 can be stored in memory 154 upon installation of the application 155 (e.g., downloading the application 155 from the server 170, an application store, or some other source). As discussed further below, the application 155 can be configured to 1) facilitate a wireless connection (e.g., wireless communication link 140) between the mobile device 150 and the wireless communication module 130, 2) send a series of requests or commands to the wireless communication module 130 for information about the offline fuel dispenser 110, and 3) upon receipt of the requested information, forward the information to the remote server 170 for analysis and processing. As such, the application 155 can operate as a bridge between the offline fuel dispenser 110 and the remote server 170. It should be appreciated that the user interface of the application 155 can be variously configured, with differently designed layouts, icons, menus, input features, and so on. Thus, the user interfaces that follow are provided merely for illustration purposes and do not limit the scope of the claimed invention in any way. Similarly, the application 155 can be configured to execute on an Android™ operating system, an iOS™ operating system, or any other operating system available for execution on the mobile device 150.

With the mobile device 150 having the application 155 installed thereon, it can be determined whether a user has registered the mobile device 150 on the remote server 170 via the application 155, at step 314. If not, the process can proceed to step 316 where the user first registers with the server 170, which may belong to the OEM, for example. The user registration can include user information being stored at the server 170 (e.g., in a memory thereof) corresponding to the user. In some implementations, the user information can include at least a user identifier and a password and, in further implementations, at least one type of additional information. The user identifier is a unique identifier for the user and can be, for example, the user's employee ID number, the user's mobile telephone number, the user's email address. a user-selected account name, or the like. Examples of the at least one type of additional information can be information not used as the user identifier, e.g., the user's address, requiring input of the user's employee ID number when the user identifier is the user's mobile number, requiring input of the user's employee ID number when the user identifier is the user's mobile number, requiring input of the user's employee ID number and/or the user's mobile number when the user identifier is a user-selected account name, etc. The user registration can occur via the application 155 or can occur outside the application 155, such as by an administrator directly registering the user at the server 170. Registration occurring outside the application 155 may provide increased security. Registration occurring via the application 155 may require an administrator to manually approve the registration request to help improve security.

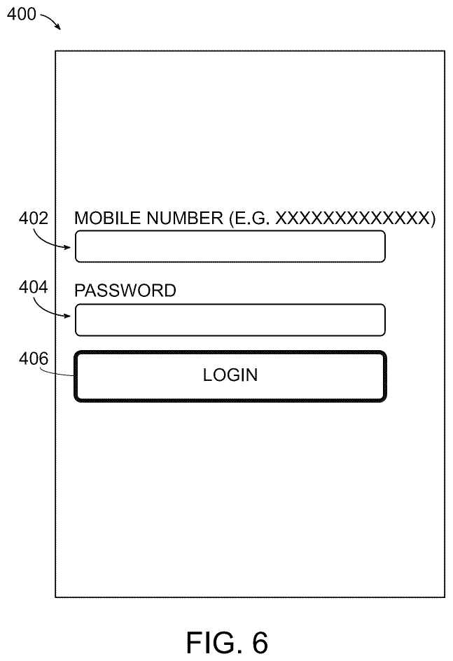

Once a user has an account registered at the server 170, the user can proceed to login to the application 155 on the mobile device 150, at step 318. For example, the user can open the application 155 on the mobile device 150, and the application 155 can prompt the user to log in. FIG. 6 illustrates one implementation of a login screen 400 for the application 155 that can be shown on the user interface 152 (e.g., the display) of the mobile device 150. As in this illustrated implementation, the login screen 400 can prompt the user to input a user identifier 402 and a password 404. The user identifier 402 is a mobile number in this illustrated implementation but can be another type of user identifier, e.g., an employee ID, a previously-chosen unique account name, etc. Once input, the user selects a submit button 406 (labeled “Login” in FIG. 6) for the input user identifier 402 and password 404 to be submitted to the server 170 for user authentication.

In response to selection of the submit button 406, the mobile device 150 can transmit an authorization request to the server 170, e.g., via the second communication link 160 over the network 180. The authorization request can include data indicative of the input user identifier 402 and password 404. In response to receiving the authorization request, the server 170 can verify whether or not the user is a registered user, e.g., whether the input user identifier 402 and password 404 matches a registered user as indicated, for example, in a database or a lookup table stored at the server 170.

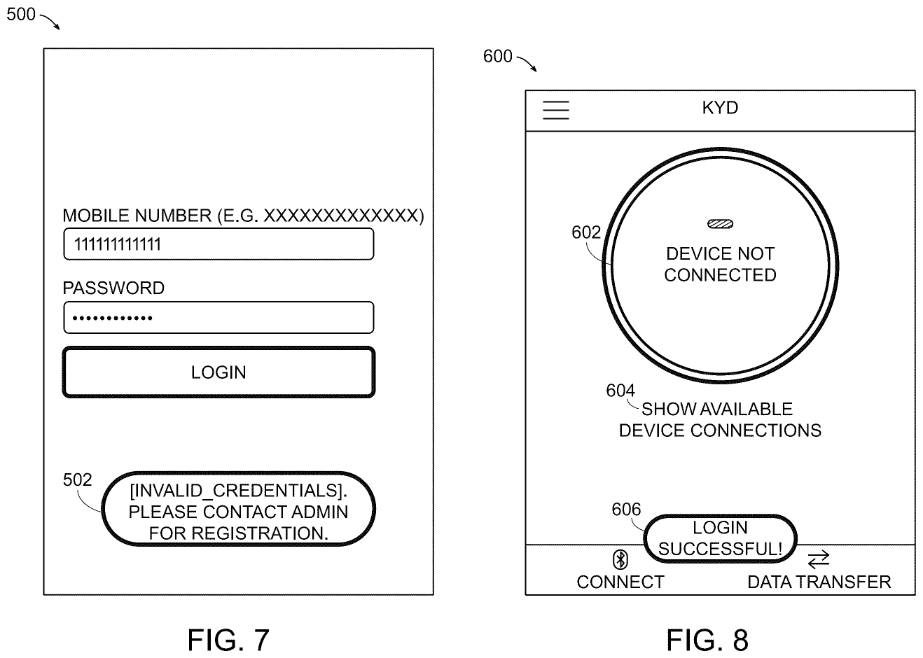

If the user is not verified by the server 170, the server can 170 transmit a failure message to the mobile device 150 indicating that login failed. In response to receiving the failure message from the server 170, an invalid login screen for the application 155 can be shown on the mobile device 150, e.g., on the user interface 152. FIG. 7 illustrates one implementation of an invalid login screen 500. The invalid login screen 500 can include a login failure message 502 indicating to the user that login was unsuccessful. The login failure message 502 can, as in this illustrated implementation, indicate that the input credentials (e.g., user identifier 402 and/or password 404) were invalid and that the user should contact their administrator for registration and/or assistance. The user may opt to retry inputting their credentials (e.g., user identifier 402 and password 404) before contacting the administrator, such as if the user has registered previously and may merely have a typographical error in the input credentials.

If the user is verified, the server 170 can transmit a success message to the mobile device 150 indicating that login succeeded. In response to receiving the success message from the server 170, a successful login screen for the application 155 can be shown on the mobile device 150, e.g., on the user interface 152. FIG. 8 illustrates one implementation of a successful login screen 600. The successful login screen 600 can include a successful login message 606 indicating to the user that login was successful. In addition, the successful login screen 600 can include a device connection status indicator 602 indicating a current status of any connection between the application 155/mobile device 150 and another device. As shown in FIG. 8, the application 155 has not initiated a connection with another device, and a message stating, “Device not connected,” is displayed. The successful login screen 600 can further include a show available connections button 604 which, upon selection, is configured to display a list of devices within range of the mobile device 150 to which the mobile device can initiate a communication session.

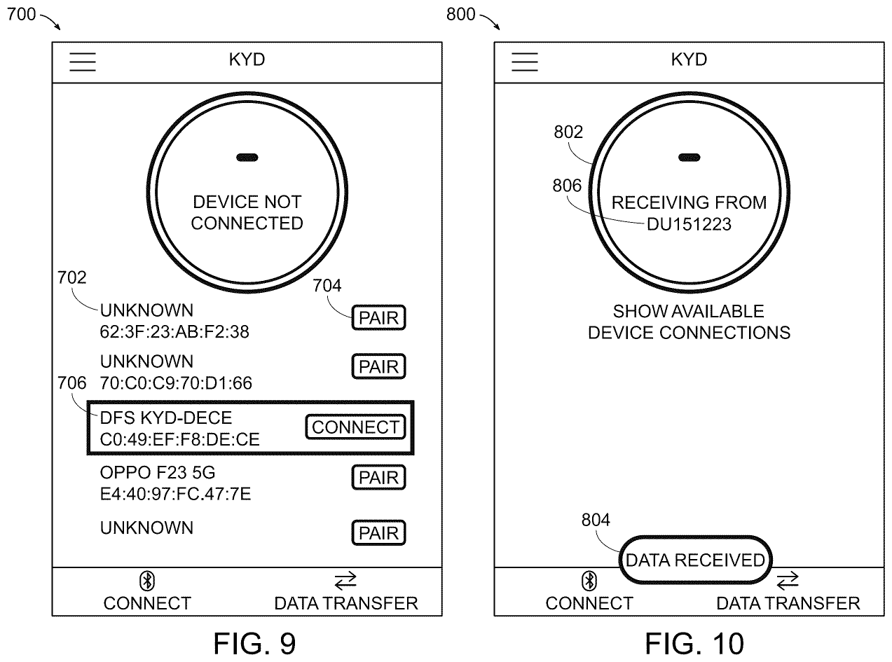

FIG. 9 illustrates one implementation of an available connections screen 700. As shown, the available connections screen 700 can include a list 702 of devices to which the mobile device 150 may connect. The mobile device 150 should be proximate (i.e., within a short-range communication radius) the offline fuel dispenser 110 and the wireless communication module 130 so that the wireless communication module 130 is displayed as an available connection. For example, assuming Bluetooth is being used for short-range communication between the mobile device 150 and the wireless communication module 130, the application 155 can use the Bluetooth protocol to scan for other devices within range and available to communicate via Bluetooth, for the purpose of identifying each of the available communication devices included in the list 702, at step 320. In some embodiments, the list 702 can include a device name along with additional identifying information, such as a MAC identifier, an IP address, a location, and the like. The available connections screen 700 can also include an initiate connection button 704 corresponding to each of the available devices shown in the list 702. In some implementations, the initiate connection button 704 can display “Pair” if the mobile device 150 has not already been paired with the corresponding communication device, or “Connect” if the mobile device 150 has previously been paired with the corresponding communication device, in which case the one-time pairing procedure is unnecessary.

Using the list 702, the user can select the device name (e.g., “DFS KYD-DECE”) 706 corresponding to the wireless communication module 130 connected to the offline fuel dispenser 110. At step 322, it can be determined whether the mobile device 150 and the wireless communication device 130 have been previously paired, and such pairing information is stored by both devices. If the devices have not been paired, or if the pairing information has since been deleted by either device, a one-time pairing procedure can be performed, at step 324. The user can initiate pairing by selecting the initiate connection button 704 which displays “Pair,” indicating that the devices need to be paired before connecting. If the devices have been paired, and the pairing information is stored at both devices, the application 155 can utilize the Bluetooth protocol (or other short-range communication protocol, depending on the implementation) to connect the mobile device 150 to the wireless communication device 150, at step 326, establishing a wireless communication session between the two devices. The wireless communication session is depicted as the first communication link 140 of FIG. 1. The user can initiate the connection by selecting the initiate connection button 704 which displays “Connect,” as shown in FIG. 9, indicating that the devices have been paired already and are able to connect to one another.

Once connected, the application 155 can begin sending requests or commands to the offline fuel dispenser 110 for information about the fuel dispenser 110. The requests for information can be sent by the application 155 directly to the wireless communication device 130, via the first wireless communication link 140, acting as a bridge between the application 155 and the fuel dispenser 110. In response, the offline fuel dispenser 110 can send the requested information to the wireless communication module 130 to be relayed back to the application 155.

FIG. 10 illustrates one implementation of a connection activation screen 800. As shown, the connection activation screen 800 can include a connection status indicator 802 indicating that data is being received by the application 155 from the offline fuel dispenser identified by the dispenser ID 806. The connection activation screen 800 can further include an active transmission message 606 indicating to the user that the dispenser 110 is actively transmitting information regarding the dispenser 110 to the application 155.

In some embodiments, the application 155 can initiate a predefined request flow defining a sequence of requests to send to the offline fuel dispenser 110, at step 328. For example, a predefined request flow can define a sequence of requests including a first request for first information regarding the fuel dispenser 110, a second request for second, different information regarding the fuel dispenser 110, and so on. The predefined request flow can be predefined by the OEM in any suitable manner, with any number of requests for any type of information, as desired. In some cases, it may be desirable to obtain information that identifies the fuel dispenser 110 first, followed by operational data stored in memory of the fuel dispenser 110, so that the identifying information can be used to re-initiate a communication session with the dispenser 110 in case the session is interrupted during transmission of the operational data stored in memory. For example, the application 155 can send a first request for first information regarding the fuel dispenser 110 including a dispenser identifier (ID) of the fuel dispenser 110, followed by a second request for second information regarding the fuel dispenser 110 including operational data stored in memory 115 of the fuel dispenser 110.

The predefined request flow can be utilized for security purposes, in some cases, such that the application 155 must send requests for information to the wireless communication device 130 in the exact sequence defined by the predefined request flow (established by the OEM, for example) otherwise the requests fail. This can act as a safeguard to prevent malicious actors from attempting to steal information from offline fuel dispensers without authorization. Since the malicious actors do not know the exact sequence of requests defined by the request flow, their requests for data can be denied.

According to one implementation, and merely for illustration purposes, the predefined request flow can define a sequence of requests for information regarding the offline fuel dispenser 110 as follows:
1) The application 155 can send a first request, at step 330, to the wireless communication module 130 for first information regarding the offline fuel dispenser 110 including identifying information such as a dispenser ID (e.g., a serial number of the dispenser), a number of electronic cards of the dispenser, types of hardware used by the dispenser, and date and time information. The application 155 can send a unique command (e.g., “KYD GET DU INFO”) which the wireless communication module 130 can relay to the fuel dispenser, and which the fuel dispenser 110 is specifically programmed to recognize and respond with the desired information. The fuel dispenser 110 can then retrieve the requested information and forward the same to the wireless communication module 130 via the serial communication link 120, and the wireless communication module 130 can in turn provide the requested information back to the mobile device 150. Once the application 155 determines that the requested information regarding the dispenser 110 has been received, at step 332, it can proceed to the second request. Notably, the information requested from the fuel dispenser 110 in the first request (e.g., the dispenser ID) can comprise information necessary to enable the application 155 to re-initiate its communication session with the fuel dispenser 110 via the wireless communication module 130 in the event that the session is disrupted during transmission of any information provided in response to subsequent requests.
2) The application 155 can send a second request, at step 330, to the wireless communication module 130 for second information regarding the offline fuel dispenser 110 including configuration information such as configuration data of the dispenser, configuration data of the pump, software version information, OTP type, and serial numbers of electronic cards in the dispenser. The application 155 can send a unique command (e.g., “KYD GET DU DATA”) which the wireless communication module 130 can relay to the fuel dispenser, and which the fuel dispenser 110 is specifically programmed to recognize and respond with the desired information. The fuel dispenser 110 can then retrieve the requested information and forward the same to the wireless communication module 130 via the serial communication link 120, and the wireless communication module 130 can in turn provide the requested information back to the mobile device 150. Once the application 155 determines that the requested information regarding the dispenser 110 has been received, at step 332, it can proceed to the third request.
3) The application 155 can send a third request, at step 330, to the wireless communication module 130 for third information regarding the offline fuel dispenser 110 including memory-related metadata such as memory type used by the dispenser, memory size in the dispenser, the number of packets of memory to be exchanged to the application 155, and so forth. The application 155 can send a unique command (e.g., “KYD GET MEM INFO”) which the wireless communication module 130 can relay to the fuel dispenser, and which the fuel dispenser 110 is specifically programmed to recognize and respond with the desired information. The fuel dispenser 110 can then retrieve the requested information and forward the same to the wireless communication module 130 via the serial communication link 120, and the wireless communication module 130 can in turn provide the requested information back to the mobile device 150. Once the application 155 determines that the requested information regarding the dispenser 110 has been received, at step 332, it can proceed to the fourth and final request.
4) The application 155 can send a fourth request, at step 330, to the wireless communication module 130 for fourth information regarding the offline fuel dispenser 110 including a complete reading of the memory devices in the dispenser 110. In one implementation, the dispenser 110 can read its internal memory devices (e.g., memory 115), one by one, in frame size of 64 bytes. The dispenser 110 can repeat this process until all data stored on its memory devices has been successfully transmitted to the application 155. The application 155 can send a unique command (e.g., “KYD DU GET PACKET”) which the wireless communication module 130 can relay to the fuel dispenser, and which the fuel dispenser 110 is specifically programmed to recognize and respond with the desired information. The fuel dispenser 110 can then retrieve the requested information and forward the same to the wireless communication module 130 via the serial communication link 120, and the wireless communication module 130 can in turn provide the requested information back to the mobile device 150.

The process of the application 155 sending a request for information to the offline fuel dispenser 110, via the wireless communication module 130, and receiving the requested information from the offline fuel dispenser 110, via the wireless communication 130, can be repeated until the predefined request flow is determined to be complete, at step 334, at which point the requests for information from the fuel dispenser terminate. For illustration, the predefined request flow described above is determined to be complete after the application 155 determines that all information requested in the “fourth request” has been received. It is to be understood, however, that the predefined request flow described above is presented for illustration purposes only and can be modified in any suitable manner according to preferences of the OEM or other managing entity. In yet other implementations, the requirement that the requests sent by the application 155 follow a predefined request flow may be omitted altogether.

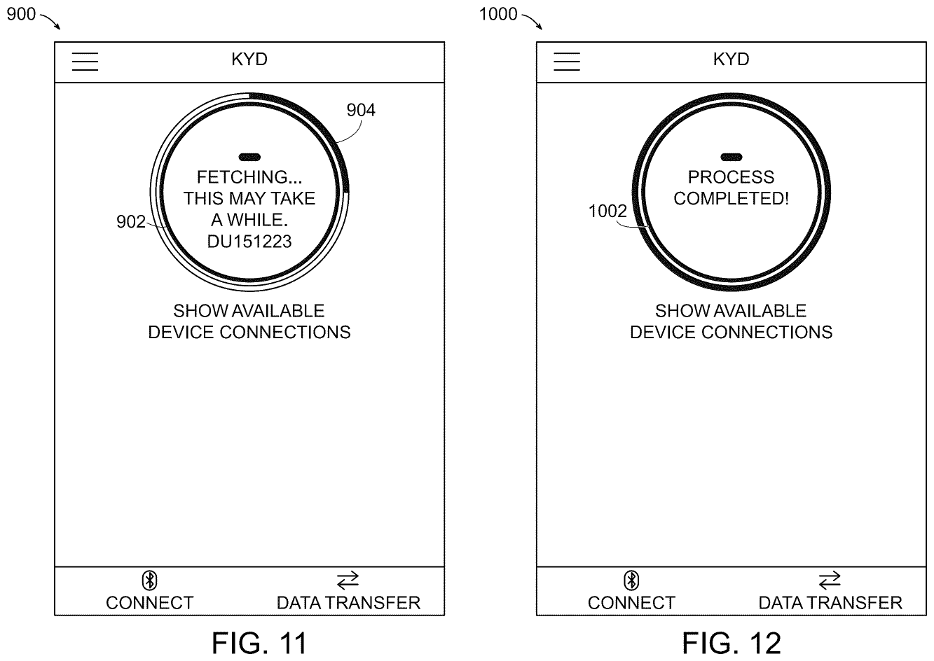

FIG. 11 illustrates one implementation of a progress update screen 900. As shown, the progress update screen 900 can include a transmission progress indicator 902 indicating a current progress of the dispenser data collection. For example, the transmission progress indicator 902 can read, “Fetching . . . This may take a while.” Such a message can be displayed while the fuel dispenser 110 performs a complete reading of its internal memory devices, for example, as these transmissions may take up to several minutes. The progress update screen 900 can further include a graphical indicator 904 indicating how close the collection is to completion, such as a bar that fills as transmission progresses, as shown in FIG. 11, a percentage, a time remaining, etc. As would be appreciated, the progress update screen 900 can provide an indication to the user that communication between the application 155 and the offline fuel dispenser 110 is ongoing, as opposed to being frozen.

Furthermore, during transmission of the information regarding the fuel dispenser 110 to the application 155, it is possible for errors to occur in which incomplete or incorrect information is transmitted, or data is dropped, resulting in faulty information. In some implementations, these errors can be detected by performing an error detection procedure during transmission. For example, the application can 155 perform a cyclic redundancy check (CRC) and monitor for the occurrence of a CRC error message, often appearing when corruption or a suspicious change is detected in data. If a CRC error message is received, the application 155 can thrown the error, and communication between the application 155 and the dispenser 110 via the wireless communication module 130 can be re-initiated (e.g., using the identifying information retrieved in response to the “first request” sent by the application 155). As would be appreciated, this is particularly useful in case an error occurs during transmission of information in response to the “fourth request,” as a complete reading of every memory device in the fuel dispenser 110 can be lengthy and thus prone to errors.

In one implementation, the fuel dispenser 110 can encrypt the information it sends to the application 155 to ensure data privacy. In some cases, all data transmitted from the fuel dispenser 110 to the application 155 can be encrypted by the dispenser 110. In other cases, only certain data transmitted from the fuel dispenser 110 to the application needs to be encrypted by the dispenser 110, such as the most critical operational data that is read from the dispenser's memory devices.

Importantly, the encrypted information that is relayed from the wireless communication module 130 to the application 155 may not be decrypted by the application 155. As a result, the encrypted information provided by the offline fuel dispenser 110 is not readable by a user of the application 155, nor decipherable by the application 155 itself. Instead, the information can be encrypted end-to-end, as the application 155 forwards the information in its encrypted format directly to the remote server 170, where the information can be decrypted, as the remote server 170 shares the appropriate decryption keys corresponding to the encryption methods employed by the fuel dispenser 110. The application 155, on the other hand, can lack the decryption keys necessary to decrypt the information, and therefore is unable to perform decryption of the information. Thus, in some embodiments, the application 155 does not actually perform any processing of the obtained information, as the information processing is performed entirely by the remote server 170.

FIG. 12 illustrates one implementation of a process completion screen 1000. As shown, the process completion screen 1000 can include a process completion indicator 902 indicating that dispenser data collection process is complete (e.g., “Process Completed!”).

Once the process of collecting the information regarding the offline fuel dispenser 110 by the application 155 is complete, the application 155 can initiate transmission of the information from the mobile device 150 to the remote server 170, at step 338. Referring back to FIG. 1, the mobile device 150 can establish a communication link, e.g., second communication link 160, via the network 180 (e.g., the public Internet, a virtual private network (VPN), or the like). In some implementations, the application 155 securely transmits the encrypted information regarding the offline fuel dispenser 110 to the remote server 170 using various techniques, such as using a Hypertext Transfer Protocol Secure (HTTPS) application programming interface (API), a secure tunneling protocol, or the like. In this way, any information provided by the offline fuel dispenser 110 can remain private and protected from potential malicious actors. In certain embodiments, information regarding the fuel dispenser 110 that is collected by the application 155 can be transmitted to the remote server 170 before the entire collection is complete, e.g., step 336. For example, collected information regarding the fuel dispenser 110 can be sent to the remote server 170 after each instance of the fuel dispenser 110 sending information, at step 332, in response to a request from the application 155. Alternatively, the collected information can be sent to the remote server 170 only once the entire data collection is complete, at step 338.

The remote server 170 can be configured to store and process the information regarding the offline fuel dispenser 110. In some implementations, the remote server 170 can decrypt the encrypted information regarding the fuel dispenser 110 (assuming the information as encrypted by the dispenser 110), parse the decrypted information, and perform analysis of the information to draw conclusions regarding a current status of the dispenser 110 (e.g., location, operational status, business or revenue-related data, whether maintenance is needed, whether tampering or security breaches have occurred, etc.), as well as inventory tracking, field trials tracking, and so on.

In some embodiments, upon processing the information regarding the offline fuel dispenser 110, the remote server 170 can be configured to provide a visual depiction of the processed information to a user interface. For example, the OEM of the fuel dispenser 110 can provide a user portal that is accessible through any terminal with an Internet connection. The user portal can be displayed on a user interface of any terminal, such as a computer, a mobile device, or other suitable computing device, as would be appreciated by a person skilled in the art. An end user (e.g., managers, dispenser operators, business executives, etc.) can utilize the user portal to track, monitor, and assess a group of fuel dispensers, which lack external network connectivity, without having to visit each dispenser for a manual diagnosis.

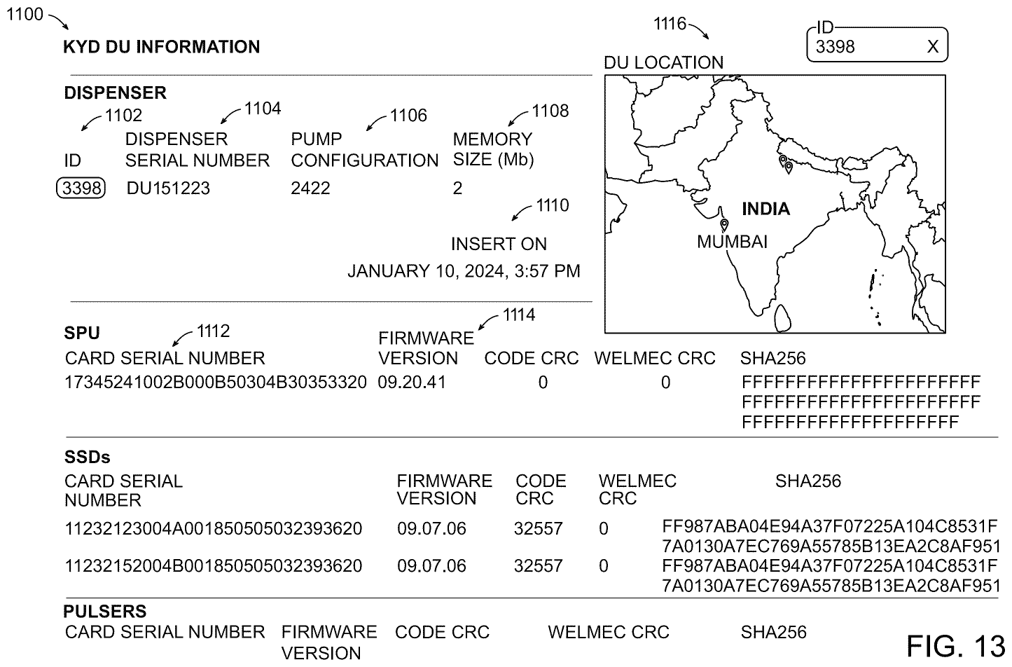

FIG. 13 illustrates one implementation of a user portal screen 1100 generated by the remote server 170 to present a visualization of information regarding one or more fuel dispensers. The user portal screen 1100 can include visualizations of any type and/or amount of information regarding the fuel dispenser 110, as well as other fuel dispensers. For example, as shown in FIG. 13, the user portal screen 1100 can display various data fields such as a dispenser ID 1102, a dispenser serial number 1104, a pump configuration 1106, memory size 1108, and a timestamp 1110. The user portal screen 1100 can also display additional configuration information, such as a card serial number 1112 and a firmware version 1114 of electronic cards in the fuel dispenser 110. The user portal screen 1100 can further include a map 1116 showing the geographical location of the fuel dispenser 110, as well as any other fuel dispensers belonging to the OEM in the geographical region.

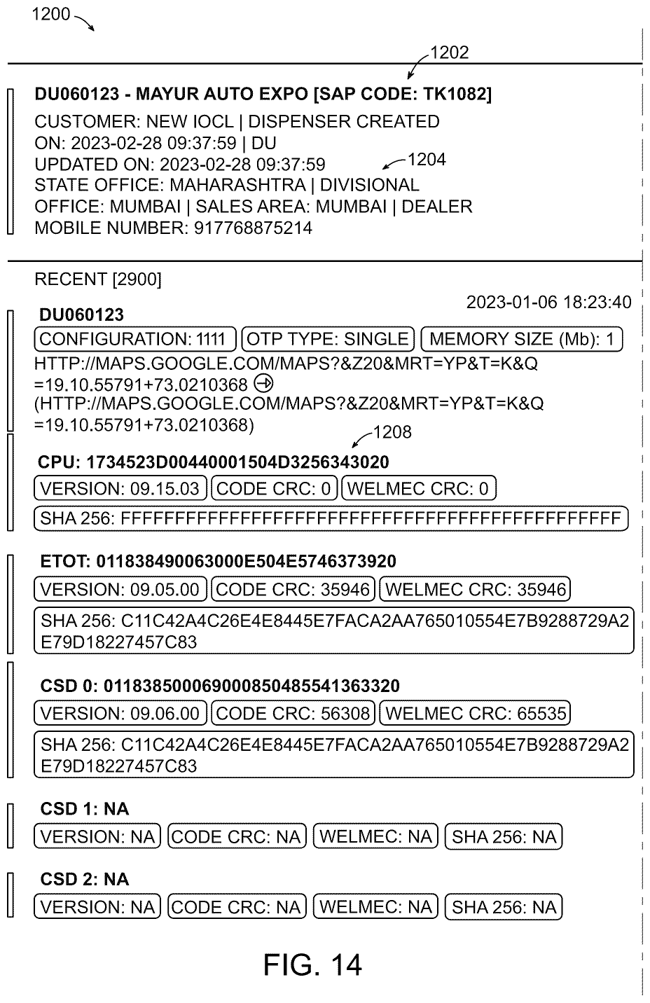

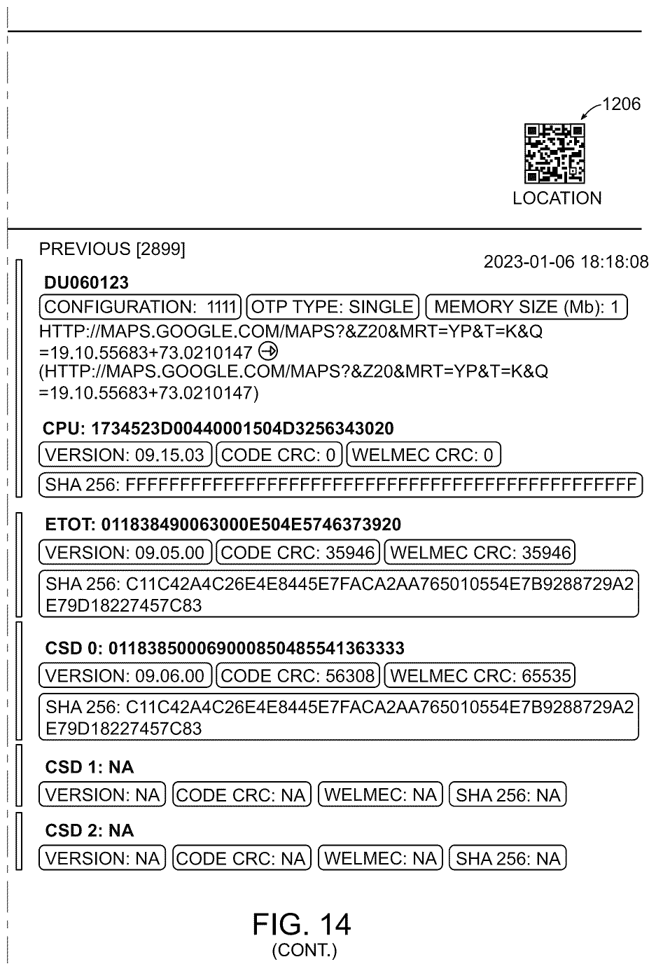

Various other user portal visualizations are envisioned. For example, FIG. 14 illustrates one implementation of another user portal screen 1200. As shown, the user portal screen 1200 can include dispenser identifying information 1202 such as a dispenser ID, a dispenser name, a dispenser code, as well ancillary dispenser information 1204 such as a customer name, dispenser creation date, sales information, dealer contact information, location information, and so forth. In some embodiments, the user portal screen 120 can include location information of the fuel dispenser 110 in the form of a QR code 1206, or alternatively, a geographical map akin to the map 1116. Furthermore, the user portal screen 1200 can include a listing of memory information 1208 retrieved from the memory devices of the dispenser 110. The memory information 1208 can include various codes that an operator can ascertain for the purposes of diagnosing the dispenser 110, determining whether maintenance is needed, evaluating performance, etc.

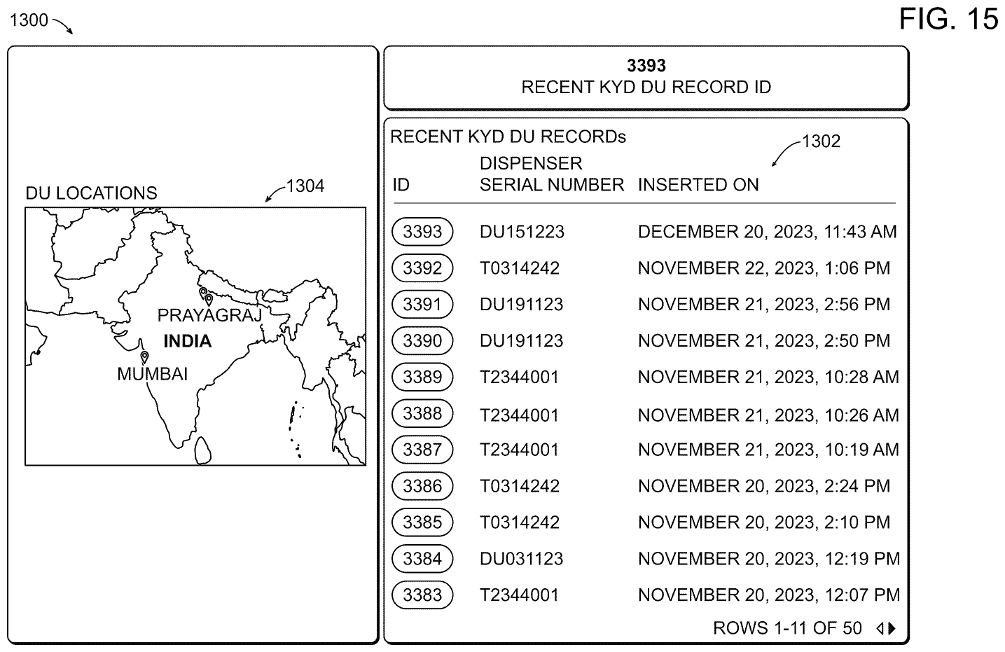

FIG. 15 illustrates one implementation of yet another user portal screen 1300. As shown, the user portal screen 1300 can include a listing 1302 of several fuel dispensers associated with the OEM, including the dispenser ID, dispenser serial number, and dispenser creation data, corresponding to each of the dispensers. The user portal screen 1300 can also include a map 1304 showing the geographical location of each fuel dispenser in the listing 1302. In some embodiments, the user can select a particular dispenser (e.g., by selecting a pin or other icon representing the dispenser) in order to receive additional information specific to the selected dispenser.

The process 300 then ends at step 340. It should be noted that while certain steps within the process 300 may be optional as described above, the steps shown in FIGS. 5A and 5B are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

The techniques described herein, therefore, allow for obtaining information relating to product dispensers that are offline, through use of a short-range wireless communication module connected to an offline product dispenser and an application executing on a mobile device that is programmed to communicate with the dispenser using a sequence of commands configured to initiate a response from the dispenser including desired information. The application can then cause the mobile device to transmit the obtained information to a remote server where the information can be parsed, processed, and in some cases provided to a user portal for access by an end user. The disclosed techniques thus allow for remote monitoring of offline product dispensers, which has otherwise been impossible without sending a technician to visit each dispenser location for a manual diagnosis.

One skilled in the art will appreciate further features and advantages of the devices, systems, and methods based on the above-described embodiments. Accordingly, this disclosure is not to be limited by what has been particularly shown and described, except as indicated by the appended claims. All publications and references cited herein are expressly incorporated herein by reference in their entirety for all purposes.

Those skilled in the art will understand that the systems, devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

The present disclosure has been described above by way of example only within the context of the overall disclosure provided herein. It will be appreciated that modifications within the spirit and scope of the claims may be made without departing from the overall scope of the present disclosure.

What is claimed is:

1. A method comprising:
establishing, by an application executing on a mobile device, a wireless communication session between the mobile device and a short-range wireless communication module connected to an offline product dispenser;
sending, by the application and via the wireless communication session, one or more requests for information regarding the offline product dispenser to the short-range wireless communication module;
receiving, by the application and via the wireless communication session, the information regarding the offline product dispenser from the short-range wireless communication module, in response to the one or more requests, wherein the offline product dispenser is configured to transmit the information regarding the offline product dispenser to the short-range wireless communication module via a communication channel of the offline product dispenser; and
transmitting, by the application, the information regarding the offline product dispenser to a remote server configured to store and process the information regarding the offline product dispenser.

2. The method of claim 1, wherein the receiving of the information regarding the offline product dispenser from the short-range wireless communication module comprises:
receiving, by the application and via the wireless communication session, the information regarding the offline product dispenser in an encrypted format from the short-range wireless communication module, in response to the one or more requests.

3. The method of claim 2, wherein the transmitting of the information regarding the offline product dispenser to the remote server comprises:
transmitting, by the application, the information regarding the offline product dispenser in the encrypted format to the remote server, the remote server being configured to perform decryption of the information regarding the offline product dispenser upon receipt.

4. The method of claim 3, wherein the application securely transmits the information regarding the offline product dispenser in the encrypted format to the remote server using a Hypertext Transfer Protocol Secure (HTTPS) application programming interface (API).

5. The method of claim 2, wherein the application is unable to perform decryption of the information regarding the offline product dispenser, such that a user is prevented from accessing contents of the information regarding the offline product dispenser on the mobile device.

6. The method of claim 1, wherein the sending of the one or more requests for information regarding the offline product dispenser to the short-range wireless communication module comprises:
sending, by the application and via the wireless communication session, the one or more requests for the information regarding the offline product dispenser to the short-range wireless communication module according to a predefined request flow defining a sequence of requests to send to the offline product dispenser.

7. The method of claim 6, wherein the offline product dispenser only provides the information regarding the offline product dispenser to the short-range wireless communication module for communication to the mobile device when a sequence of the one or more requests sent by the mobile device matches the sequence of requests defined by the predefined request flow.

8. The method of claim 6, wherein the sequence of requests defined by the predefined request flow comprises at least: a first request for a dispenser identifier (ID) of the offline product dispenser followed by a second request for operational data stored in memory of the offline product dispenser.

9. The method of claim 8, further comprising:
detecting, by the application, a disruption of the wireless communication session during transmission of the operational data from the short-range wireless communication module to the mobile device; and
re-establishing, by the application, the wireless communication session between the mobile device and the short-range wireless communication module using the dispenser ID.

10. The method of claim 1, wherein the sending of the one or more requests for information regarding the offline product dispenser to the short-range wireless communication module comprises:
sending, by the application and via the wireless communication session, one or more first requests for first information regarding the offline product dispenser to the short-range wireless communication module;
receiving, by the application and via the wireless communication session, the first information regarding the offline product dispenser from the short-range wireless communication module, in response to the first one or more requests;
transmitting, by the application, the first information regarding the offline product dispenser to the remote server; and
after transmitting the first information regarding the offline product dispenser to the remote server, sending, by the application and via the wireless communication session, one or more second requests for second information regarding the offline product dispenser to the short-range wireless communication module, the second information regarding the offline product dispenser being different than the first information regarding the offline product dispenser.

11. The method of claim 1, wherein the short-range wireless communication module is configured to communicate using a short-range communication protocol selected from a group consisting of: a Bluetooth protocol, a Wi-Fi protocol, a near-field communication (NFC) protocol, and an ultra-wideband (UWB) protocol.

12. The method of claim 1, wherein the communication channel of the offline product dispenser via which the offline product dispenser transmits the information regarding the offline product dispenser to the short-range wireless communication module is a serial communication channel.

13. The method of claim 12, wherein the short-range wireless communication module is connected externally to a serial communication port of the offline product dispenser connected to the serial communication channel, the offline product dispenser being configured to transmit the information regarding the offline product dispenser to the short-range wireless communication module over the serial communication port.

14. The method of claim 1, further comprising:
performing, by the application and via the application, a user authentication procedure prior to establishing the wireless communication session between the mobile device and the short-range wireless communication module, wherein the wireless communication session is only established when the user authentication procedure is successful.

15. The method of claim 1, further comprising:
performing, by the application and via the application, an initial pairing procedure between the mobile device and the short-range wireless communication module, wherein the wireless communication session is established after completion of the initial pairing procedure.

16. The method of claim 1, wherein, having processed the information regarding the offline product dispenser, the remote server is further configured to provide a visual depiction of the processed information regarding the offline product dispenser to a user interface.

17. The method of claim 1, wherein the application transmits the information regarding the offline product dispenser to the remote server without having processed the information regarding the offline product dispenser.

18. The method of claim 1, wherein the offline product dispenser is a fuel dispenser.

19. An apparatus comprising:
one or more network interfaces to communicate with a network;
a processor coupled to the one or more network interfaces and configured to execute one or more processes; and
a memory configured to store a process executable by the processor, the process when executed causing the processor to:
establish, via an application executing on the apparatus, a wireless communication session between the mobile device and a short-range wireless communication module connected to an offline product dispenser;
send, via the wireless communication session, one or more requests for information regarding the offline product dispenser to the short-range wireless communication module;
receive, via the wireless communication session, the information regarding the offline product dispenser from the short-range wireless communication module, in response to the one or more requests, wherein the offline product dispenser transmits the information regarding the offline product dispenser to the short-range wireless communication module via a communication channel of the offline product dispenser; and
transmit the information regarding the offline product dispenser to a remote server configured to store and process the information regarding the offline product dispenser.

20. A system comprising:
an offline product dispenser connected to a short-range wireless communication module, wherein the offline product dispenser is configured to communicate with the short-range wireless communication module via a communication channel of the offline product dispenser;
a remote server; and
a mobile device executing an application, the application being configured to:
establish a wireless communication session between the mobile device and the short-range wireless communication module;
send, via the wireless communication session, one or more requests for information regarding the offline product dispenser to the short-range wireless communication module;
receive, via the wireless communication session, the information regarding the offline product dispenser from the short-range wireless communication module, in response to the one or more requests, wherein the offline product dispenser transmits the information regarding the offline product dispenser to the short-range wireless communication module via the communication channel; and
transmit the information regarding the offline product dispenser to the remote server being configured to store and process the information regarding the offline product dispenser.
